(19) United States
(12) Patent Application Publication
(10) Pub. No.: US 2003/0192251 A1
(43) Pub. Date: Oct. 16, 2003

(54) Steam reforming fuel processor

(76) Inventors: David J. Edlund, Bend, OR (US); Arne LaVen, Bend, OR (US); Timothy G. Mace, Bend, OR (US); William A. Pledger, Sisters, OR (US); R. Todd Studebaker, Bend, OR (US); Douglas J. Wambaugh, Bend, OR (US)

Correspondence Address: Kolisch, Hartwell, P.C., Suite 200, 520 S.W. Yamhill Street, Portland, OR, 97204, US

(21) Appl. No.: 10/407,500

(22) Filed: Apr. 4, 2003

Related U.S. Application Data
(60) Provisional application No. 60/372,258, filed on Apr. 12, 2002.

(51) Int. Cl. B01J 8/00

(52) U.S. Cl. 48/127.9; 48/197 R; 48/198.1; 48/198.3; 48/198.7; 48/211; 48/212; 48/214 R; 422/187; 422/188; 422/189; 422/190; 422/191; 422/193; 422/194; 422/196; 422/197; 422/198; 422/201; 422/202; 422/204; 422/211

(57) ABSTRACT

A steam reformer that produces hydrogen gas from water and a carbon-containing feedstock, such as an alcohol or a hydrocarbon. The steam reformer includes a hydrogen-producing region, in which a mixed gas stream containing hydrogen gas and other gases is produced from water and a carbon-containing feedstock. The steam reformer includes a separation region, in which the mixed gas stream is separated into a hydrogen-rich stream containing at least substantially pure hydrogen gas, and a byproduct stream containing at least a substantial portion of the other gases. In some embodiments, the steam reformer is a vertically oriented fuel processor. In some embodiments, the separation region includes at least one hydrogen-selective membrane. In some embodiments, the steam reformer further includes a polishing region, in which the hydrogen-rich stream produced in the separation region is further purified. In some embodiments, the reformer includes an external metal or sealed ceramic shell.

### RELATED APPLICATION

The present application claims priority to similarly entitled U.S. Provisional Patent Application Serial No. 60/372,258, which was filed on Apr. 12, 2002 and the complete disclosure of which is hereby incorporated by reference for all purposes.

### FIELD OF THE DISCLOSURE

The present disclosure relates generally to fuel processors that produce hydrogen gas, and more particularly to a steam reformer that produces hydrogen gas from a carbon-containing feedstock and water.

### BACKGROUND OF THE DISCLOSURE

Purified hydrogen is used in the manufacture of many products including metals, edible fats and oils, and semiconductors and microelectronics. Purified hydrogen is also an important fuel source for many energy conversion devices. For example, fuel cells use purified hydrogen and an oxidant to produce an electrical potential. Various processes and devices may be used to produce the hydrogen gas that is consumed by the fuel cells. One such process is steam reforming, in which hydrogen gas is produced from a carbon-containing feedstock and water.

### SUMMARY OF THE DISCLOSURE

The present disclosure is directed to a steam reformer that produces hydrogen gas from water and a carbon-containing feedstock, such as an alcohol or a hydrocarbon. The steam reformer includes a hydrogen-producing region, in which a mixed gas stream containing hydrogen gas and other gases is produced from water and a carbon-containing feedstock. The steam reformer includes a separation region, in which the mixed gas stream is separated into a hydrogen-rich stream containing at least substantially pure hydrogen gas, and a byproduct stream containing at least a substantial portion of the other gases. In some embodiments, the steam reformer is a vertically oriented fuel processor. In some embodiments, the separation region includes at least one hydrogen-selective membrane. In some embodiments, the steam reformer further includes a polishing region, in which the hydrogen-rich stream produced in the separation region is further purified. In some embodiments, the reformer includes an external metal or sealed ceramic shell.

### BRIEF DESCRIPTION OF THE DRAWINGS

FIG. 1 is a schematic view of a fuel processing system.

FIG. 2 is a schematic view of a fuel processing system that includes a steam reformer.

FIG. 3 is a schematic view of the fuel processing system of FIG. 2, further including a polishing region.

FIG. 4 is a schematic view of a fuel cell system that includes a fuel cell stack and a steam reformer according to the present disclosure.

FIG. 5 is a schematic cross-sectional view of a steam reformer according to the present disclosure.

FIG. 6 is a schematic cross-sectional view of another steam reformer according to the present disclosure.

FIG. 7 is a cross-sectional view of an illustrative vaporization region for steam reformers according to the present disclosure.

FIG. 8 is a fragmentary cross-sectional view illustrating exemplary configurations for the vaporization, reforming and/or purification regions of steam reformers according to the present disclosure.

FIG. 9 is a fragmentary cross-sectional view illustrating reforming and separation regions of steam reformers according to the present disclosure.

FIG. 10 is a fragmentary cross-sectional view illustrating reforming and separation regions of other steam reformers according to the present disclosure.

FIG. 11 is a side elevation view of another steam reformer according to the present disclosure.

FIG. 12 is an exploded isometric view of the steam reformer of FIG. 11.

FIG. 13 is a cross-sectional view of the steam reformer of FIG. 11 taken along the line 13-13 in FIG. 11.

FIG. 14 is a cross-sectional view of the steam reformer of FIG. 11 taken along the line 14-14 in FIG. 11.

FIG. 15 is a cross-sectional view of the steam reformer of FIG. 11 taken along the line 15-15 in FIG. 14.

FIG. 16 is an isometric view of another steam reformer according to the present disclosure.

FIG. 17 is a fragmentary cross-sectional view of the steam reformer of FIG. 16 taken along the line 17-17 in FIG. 16.

FIG. 18 is a cross-sectional view of the steam reformer of FIG. 16 taken along the line 18-18 in FIG. 16.

FIG. 19 is a cross-sectional view of the steam reformer of FIG. 17 taken along the line 19-19 in FIG. 18.

FIG. 20 is an isometric view of a ceramic shell for a steam reformer or other fuel processor.

FIG. 21 is a cross-sectional view of the shell of FIG. 20 being used to house a steam reformer according to the present disclosure.

FIG. 22 is a fragmentary cross-sectional view of a portion of the shell of FIG. 21.

FIG. 23 is a cross-sectional view of another ceramic shell according to the present disclosure.

FIG. 24 is an isometric view of another ceramic shell according to the present disclosure.

FIG. 25 is a cross-sectional view of another ceramic shell according to the present disclosure.

### DETAILED DESCRIPTION AND BEST MODE OF THE DISCLOSURE

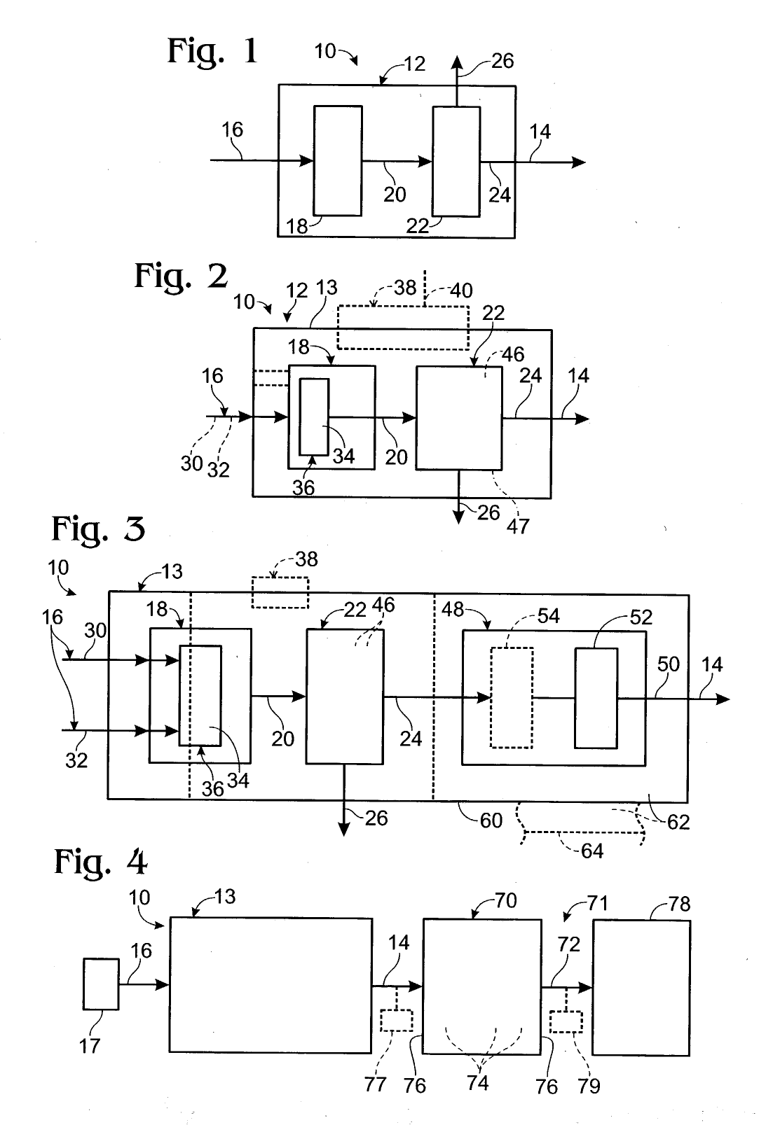

A fuel processing system 10 is schematically illustrated in FIG. 1. System 10 includes a fuel processor 12 that is adapted to produce a product hydrogen stream 14 from a feed stream 16. As shown, fuel processor 10 includes a hydrogen-producing region 18, in which a mixed gas stream 20 containing hydrogen gas and other gases is produced, and a separation region, or separation assembly, 22, in which the mixed gas stream is separated into a hydrogen-rich stream 24, which contains at least substantially pure hydrogen gas, and a byproduct stream 26, which contains at least a substantial portion of the other gases. At least a substantial portion of hydrogen-rich stream 24 forms product hydrogen stream 14. The byproduct stream may be used as a combustible fuel, exhausted, sent to a burner, used as a heated fluid stream, stored for later use, etc.

A variety of mechanisms may be used to produce mixed gas stream 20 from a variety of feed streams 16. For example, electrolysis is a hydrogen-producing process in which hydrogen gas and oxygen gas is produced from water. Other types of hydrogen-producing mechanisms, such as partial oxidation and pyrolysis, utilize a feed stream consisting of a carbon-containing feedstock, such as an alcohol or a hydrocarbon, to produce the mixed gas stream. In still other mechanisms, feed stream 16 includes water 30 and a carbon-containing feedstock 32, such as schematically illustrated in FIG. 2. Examples of suitable carbon-containing feedstocks include alcohols and hydrocarbons. Nonexclusive examples of suitable alcohols include methanol, ethanol, and polyols, such as ethylene glycol and propylene glycol. Examples of suitable hydrocarbons include methane, propane, natural gas, diesel, kerosene, gasoline and the like.

An example of a hydrogen-producing mechanism in which feed stream 16 comprises water and a carbon-containing feedstock is steam reforming. In a steam reforming process, hydrogen-producing region 18 contains a reforming catalyst 34. In such an embodiment, fuel processor 12 may be referred to as a steam reformer (as graphically illustrated in FIG. 2 at 13), hydrogen-producing region 18 may be referred to as a reforming region 36, and mixed gas stream 20 may be referred to as a reformate stream. Examples of suitable steam reforming catalysts include copper-zinc formulations of low temperature shift catalysts and a chromium formulation sold under the trade name KMA by Süd-Chemie, although others may be used. The other gases that are typically present in the reformate stream include carbon monoxide, carbon dioxide, methane, steam and/or unreacted carbon-containing feedstock.

Preferably, steam reformer 13 is adapted to produce substantially pure hydrogen gas, and even more preferably, the fuel processor is adapted to produce pure hydrogen gas. For the purposes of the present disclosure, substantially pure hydrogen gas is greater than 90% pure, preferably greater than 95% pure, more preferably greater than 99% pure, and even more preferably greater than 99.5% pure. Examples of suitable steam reformers are disclosed in U.S. Pat. Nos. 6,221,117 and 6,319,306, and in pending U.S. patent application Ser. No. 09/802,361, which was filed on Mar. 8, 2001, and is entitled “Fuel Processor and Systems and Devices Containing the Same,” each of which is incorporated by reference in its entirety for all purposes.

Feed stream 16 may be delivered to steam reformer 13 via any suitable mechanism. A single feed stream 16 is shown in FIG. 2, but it is within the scope of the disclosure that more than one stream 16 may be used and that these streams may contain the same or different components. When the carbon-containing feedstock 32 is miscible with water, the feedstock is typically delivered in the same fluid conduit as the water component of feed stream 16, such as shown in FIG. 2. When the carbon-containing feedstock is immiscible or only slightly miscible with water, these components are typically delivered to fuel processor 10 in separate streams, such as shown in FIG. 3.

Steam reformers typically operate at temperatures in the range of 200° C. and 700° C., and at pressures in the range of 50 psi and 300 psi, although temperatures and pressures outside of this range are within the scope of the disclosure. When the carbon-containing feedstock is an alcohol, the steam reforming reaction will typically operate in a temperature range of approximately 200-500° C., and when the carbon-containing feedstock is a hydrocarbon, a temperature range of approximately 400-700° C. will be used for the steam reforming reaction. As such, feed stream 16 is typically delivered to the fuel processor at a selected pressure, such as a pressure within the illustrative range presented above. To heat steam reformer 13 to a selected operating temperature, such as a temperature within the illustrative range presented above, the steam reformer typically includes or is associated with a heating assembly 38, which is adapted to heat the steam reformer. Heating assembly 38 is schematically illustrated in FIG. 2 to graphically depict that the heating assembly may be located within the steam reformer, external the steam reformer, or both. Heating assembly 38 may utilize any suitable heating mechanism or device to heat the steam reformer to a selected operating temperature. For example, heating assembly 38 may include a resistance heater, a burner or other combustion unit that produces a heated exhaust stream, heat exchange with a heated fluid stream, etc. In FIG. 2, heating assembly 38 is shown including a fuel stream 40, which will tend to vary in composition and type depending upon the mechanism(s) used to produce heat. For example, when the heating assembly 38 is a burner or otherwise creates heat by combustion, stream 40 will include a stream of a combustible fuel, such as an alcohol or hydrocarbon, and/or a combustible gas, such as hydrogen gas. When heating assembly 38 includes an electric resistance heater, then stream 40 will include an electrical connection to an electrical power source. In some embodiments, feed stream 16 may be delivered to the steam reformer at an elevated temperature, and accordingly may provide at least a portion of the required heat. When a burner or other combustion chamber is used, a fuel stream is consumed and a heated exhaust stream is produced.

Separation region 22 may utilize any suitable separation structure to separate mixed gas stream 20 into hydrogen-rich stream 24 and byproduct stream 26. Although only a single one of each of these streams has been schematically illustrated in FIGS. 1 and 2, it is within the scope of the disclosure that separation region 22 may produce more than one of each of these streams, which may thereafter be combined before or after leaving the separation region.

A suitable separation structure for separation region 22 is one or more hydrogen-permeable and/or hydrogen-selective membranes, such as schematically illustrated in FIGS. 2 and 3 at 46. The membranes may be formed of any hydrogen-permeable material suitable for use in the operating environment and parameters in which separator region 22 is operated. Examples of suitable materials for membranes 46 include palladium and palladium alloys, and especially thin films of such metals and metal alloys. Palladium alloys have proven particularly effective, especially palladium with 35 wt % to 45 wt % copper. A palladium-copper alloy that contains approximately 40 wt % copper has proven particularly effective, although other relative concentrations and components may be used within the scope of the disclosure.

Hydrogen-selective membranes are typically formed from a thin foil that is approximately 0.001 inches thick. It is within the scope of the present disclosure, however, that the membranes may be formed from other hydrogen-permeable and/or hydrogen-selective materials, including metals and metal alloys other than those discussed above as well as non-metallic materials and compositions, and that the membranes may have thicknesses that are greater or less than discussed above. For example, the membrane may be made thinner, with commensurate increase in hydrogen flux. Examples of suitable mechanisms for reducing the thickness of the membranes include rolling, sputtering and etching. A suitable etching process is disclosed in U.S. Pat. No. 6,152,995, the complete disclosure of which is hereby incorporated by reference for all purposes. Examples of various membranes, membrane configurations, and methods for preparing the same are disclosed in U.S. Pat. Nos. 6,221,117, 6,319,306, and 6,537,352, the complete disclosures of which are hereby incorporated by reference for all purposes.

Another example of a suitable pressure-separation process for use in separation region 22 is pressure swing absorption, as schematically illustrated at 47 in FIG. 2 with a dash-dot line. In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 20. The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities are retained on the adsorbent material. Impurity gases such as NH₃, H₂S, and H₂O adsorb very strongly on the adsorbent material and are therefore removed from stream 20 along with other impurities. If the adsorbent material is going to be regenerated and these impurities are present in stream 20, separation region 22 preferably includes a suitable device that is adapted to remove these impurities prior to delivery of stream 20 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. It is within the scope of the disclosure, however, that other suitable adsorbent material compositions, forms and configurations may be used.

Steam reformer 13 may, but does not necessarily, further include a polishing region 48, such as shown in FIG. 3. Polishing region 48 receives hydrogen-rich stream 24 from separation region 22 and further purifies the stream by reducing the concentration of, or removing, selected components therein. In FIG. 3, the purified hydrogen stream is indicated schematically at 50 and at least a substantial portion of this stream forms product hydrogen stream 14. For example, when stream 14 is intended for use in a fuel cell stack, compositions that may damage the fuel cell stack, such as carbon monoxide and carbon dioxide, may be removed from the hydrogen-rich stream, if necessary. For fuel cell stacks, such as proton exchange membrane (PEM) and alkaline fuel cell stacks, the concentration of carbon monoxide is preferably less than 10 ppm (parts per million). Preferably, the concentration of carbon monoxide is less than 5 ppm, and even more preferably, less than 1 ppm. The concentration of carbon dioxide may be greater than that of carbon monoxide. For example, concentrations of less than 25% carbon dioxide may be acceptable. Preferably, the concentration is less than 10%, even more preferably, less than 1%. Especially prefeffed concentrations are less than 50 ppm. The acceptable minimum concentrations presented herein are illustrative examples, and concentrations other than those presented herein may be used and are within the scope of the present disclosure. For example, particular users or manufacturers may require minimum or maximum concentration levels or ranges that are different than those identified herein.

Region 48 includes any suitable structure for removing or reducing the concentration of the selected compositions in stream 24. For example, when the product stream is intended for use in a PEM fuel cell stack or other device that will be damaged if the stream contains more than determined concentrations of carbon monoxide or carbon dioxide, it may be desirable to include a methanation catalyst 52. Methanation catalyst 52 converts carbon monoxide and carbon dioxide into methane and water, both of which will not damage a PEM fuel cell stack. Polishing region 48 may also include reforming catalyst 54 to convert any unreacted feedstock into hydrogen gas. In such an embodiment, it is preferable that the reforming catalyst is upstream from the methanation catalyst so as not to reintroduce carbon dioxide or carbon monoxide downstream of the methanation catalyst.

In FIG. 3, steam reformer 13 is shown including a shell 60 in which the above-described components are contained. Shell 60, which also may be referred to as a housing, enables the components of the steam reformer to be moved as a unit. It also protects the components of the steam reformer from damage by providing a protective enclosure and reduces the heating demand of the fuel processor because the components of the fuel processor may be heated as a unit. Shell 60 may, but does not necessarily, include insulating material 62, such lo as a solid insulating material, blanket insulating material, and/or an air-filled, gas-filled, or vacuum cavity. It is within the scope of the disclosure, however, that the steam reformer may be formed without a housing or shell. When steam reformer 13 includes insulating material 62, the insulating material may be internal the shell, external the shell, or both. When the insulating material is external a shell containing the above-described reforming, separation and/or polishing regions, the steam reformer may further include an outer cover or jacket 64 external the insulation, as schematically illustrated in FIG. 3.

It is further within the scope of the disclosure that one or more of the components of steam reformer 13 may either extend beyond the shell or be located external at least shell 60. For example, and as schematically illustrated in FIG. 3 with dashed lines, polishing region 48 may be external shell 60 and/or a portion of hydrogen-producing region 18 (such as portions of one or more reforming catalyst beds) may extend beyond the shell.

As schematically illustrated in FIG. 4, steam reformers according to the present disclosure may be adapted to deliver at least a portion of product hydrogen stream 14 to at least one fuel cell stack 70, which produces an electric current 72 therefrom. In such a configuration, the fuel processor and fuel cell stack may be referred to as a fuel cell system 71. Although the reformer has been indicated at 13 in FIG. 4, it is within the scope of the disclosure that any of the steam reformers disclosed, illustrated and/or incorporated herein may be incorporated into a fuel cell system. Fuel cell stack 70 is adapted to produce an electric current from the portion of product hydrogen stream 14 delivered thereto. In the illustrated embodiment, a single steam reformer 13 and a single fuel cell stack 70 are shown and described. However, it is within the scope of the disclosure that more than one of either or both of these components may be used. It is also within the scope of the disclosure that these components have been schematically illustrated and that the fuel cell system may include additional components that are not specifically illustrated in the figures, such as feed pumps, air delivery systems, heat exchangers, heating assemblies, batteries, power management modules, and the like.

Fuel cell stack 70 contains at least one, and typically multiple, fuel cells 74 that are adapted to produce an electric current 72 from the portion of the product hydrogen stream 14 delivered thereto. A fuel cell stack typically includes multiple fuel cells 74 joined together between common end plates 76, which contain fluid delivery/removal conduits (not shown). Examples of suitable fuel cells include proton exchange membrane (PEM) fuel cells and alkaline fuel cells. Fuel cell stack 70 may receive all of product hydrogen stream 14. Some or all of stream 14 may additionally, or alternatively, be delivered, via a suitable conduit, for use in another hydrogen-consuming process, burned for fuel or heat, or stored for later use. In dashed lines in FIG. 4, the fuel processing system (or fuel cell system) is shown including an optional hydrogen storage device 77, which is adapted to store at least a portion of the product hydrogen stream, such as for later delivery to fuel cell stack 70, for use as a fuel stream, etc. Illustrative examples of suitable hydrogen storage devices include pressurized tanks and hydride beds.

The electric current produced by the stack may be used to satisfy the energy demands, or applied load, of at least one associated energy-consuming device 78. Illustrative examples of devices 78 include, but should not be limited to, motor vehicles, recreational or industrial vehicles, boats or other seacraft, tools, lights or lighting assemblies, appliances (such as a household or other appliance), households or other dwellings, offices, stores or business establishments, computers, industrial equipment, signaling or communication equipment, etc. Device 78 is schematically illustrated in FIG. 4 and is meant to represent one or more devices or collection of devices that are adapted to draw electric current from the fuel cell system.

In dashed lines in FIG. 4, an optional energy storage device 79 is shown. Device 79 is adapted to store at least a portion of the electric current produced by the fuel cell stack and selectively use this stored current (or potential) to satisfy an applied load, such as from device(s) 78, the fuel processing (or fuel cell) system, etc. Examples of suitable energy storage devices include batteries, fly wheels and capacitors. As described above, devices 78 are adapted to apply a load to the fuel cell system (such as to one or more of the energy storage device and the fuel cell stack), with the system being adapted to provide an electric current to satisfy the applied load.

Feed stream 16 is typically delivered to the steam reformer by a suitable feed stream delivery system, such as schematically illustrated at 17 in FIG. 4. Delivery system 17 includes any suitable mechanism, device, or combination thereof that delivers the feed stream to steam reformer 13. For example, the delivery system may include one or more pumps that deliver the components of stream 16 from one or more supplies. Additionally, or alternatively, system 17 may include a valve assembly adapted to regulate the flow of the components from a pressurized supply. The supplies may be located external of the fuel processing system, or may be contained within or adjacent the system.

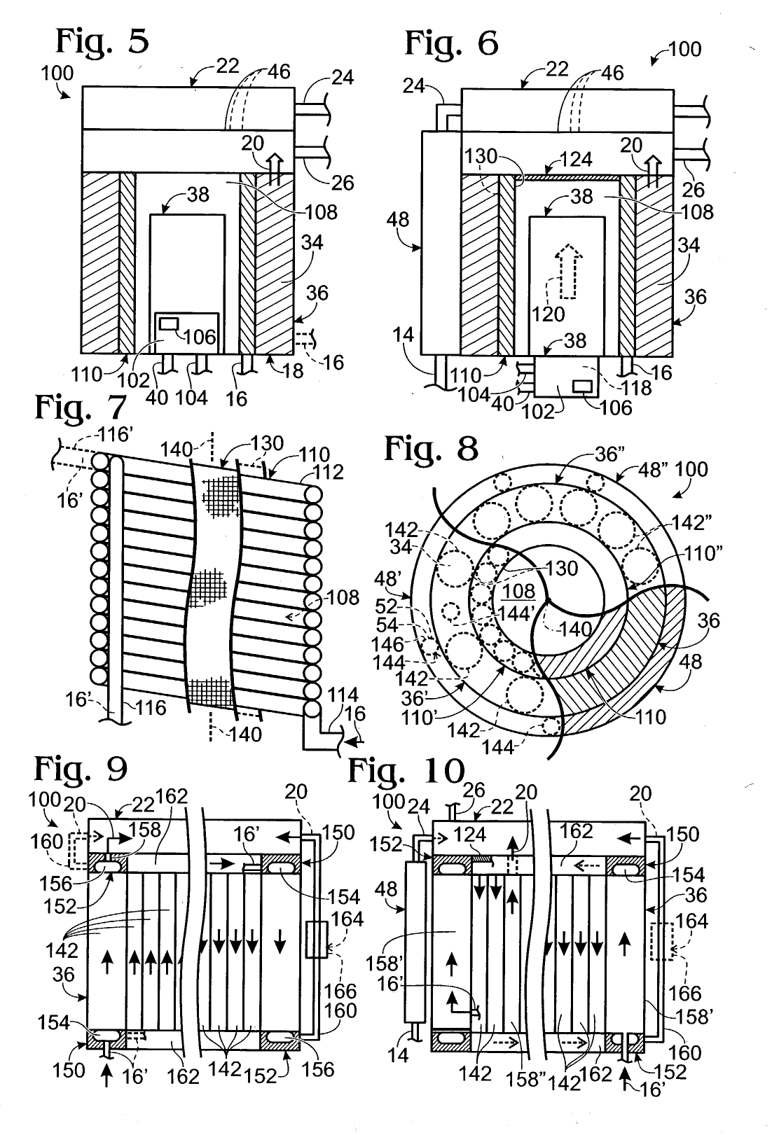

In FIG. 5, a schematic cross-sectional view of a steam reformer according to the present disclosure is shown and generally indicated at 100. Reformer 100 has the same components as the reformer previously illustrated and described in connection with FIG. 2. It is within the scope of the disclosure that reformer 100 may be used in any of the fuel processing or fuel cell systems described, illustrated and/or incorporated herein and reformer 100 may include any of the elements, subelements and variations described, illustrated and/or incorporated herein. Similarly, the other reformers described, illustrated and/or incorporated herein may also include the elements described, illustrated and/or incorporated with respect to reformer 100.

As shown, reformer 100 includes a centrally located heating assembly 38. In the illustrated embodiment, heating assembly 38 includes an ignition region 102, in which the combustion of fuel stream 40, typically along with an air stream 104, is initiated. Also shown in FIG. 5 is an ignition source 106, such as one or more of a spark plug, glow plug, combustion catalyst, pilot light or other suitable mechanism or device for initiating combustion of fuel stream 40. As shown, the heating assembly is positioned within a heating chamber 108 of the steam reformer, from which the heat generated by the heating assembly is passed to the other components of steam reformer 100. In embodiments of reformer 100 in which the heating assembly includes a burner or other combustion source, the heating chamber may be referred to as a combustion region. As schematically illustrated in FIG. 6, heated exhaust gases are generated and/or emitted from ignition region 102 into combustion chamber 108.

In the illustrative embodiment of FIG. 5, the heating assembly is centrally located within the heating chamber and is entirely, or essentially entirely, contained within the chamber. However, it is within the scope of the disclosure that the heating assembly may be otherwise located within or relative to the steam reformer, such as discussed and illustrated above with respect to FIGS. 2 and 3, and as shown in FIG. 6, in which the ignition region is located generally external the region bounded by the subsequently described vaporization region 110. Configurations intermediate these illustrative positions are also within the scope of the disclosure, such as a heating assembly that is partially within the vaporization region and partially external the vaporization region.

As discussed previously, for a steam reforming fuel processor, feed lo stream 16 includes water and at least one of an alcohol and a hydrocarbon. The feed stream should be at least substantially, and preferably completely, gaseous prior to delivery to reforming region 36. When feed stream 16 is gaseous at the operating parameters in which it is delivered to reformer 13, then the feed stream may be delivered directly to the reforming region, such as illustrated in dashed lines in FIG. 5. However, even with a gaseous feed stream 16, it may be preferable for the stream to be heated to at least the selected reforming temperature prior to delivering the stream to the reforming region. For example, the feed stream may pass through combustion region 108 or otherwise travel through or around reformer 100 to be heated prior to delivery to reforming region 36. In many embodiments, it is preferable for the feed stream to be heated to a temperature that is greater than the selected reforming temperature because of the endothermic nature of the steam reforming reaction.

In many embodiments, feed stream 16 will be delivered to the steam reformer in at least substantially a liquid phase. As discussed, immiscible components of stream 16, such as water and a carbon-containing feedstock 32 that is not miscible in water (i.e., most hydrocarbons), may be delivered in separate streams prior to vaporization. Miscible feed stream components, such as water and an alcohol or other water-soluble carbon-containing feedstock will typically be delivered in a single stream. In embodiments where feed stream 16 is at least substantially a liquid-phase stream when it is delivered to the steam reformer, the feed stream is vaporized in a vaporization region 110 of the steam reformer prior to deliver to reforming region 36. In the illustrated embodiment, the vaporization region extends around the heating assembly. Although shown concentrically positioned and radially spaced from heating assembly 38, it is within the scope of the disclosure that the vaporization region may be otherwise located within, or even external, the reformer. Similarly, vaporization region 110 may be in contact with the heating assembly or positioned other than concentrically relative to the heating assembly.

An illustrative example of a suitable vaporization region 110 is shown in FIG. 7. As shown, the vaporization region includes a coiled conduit 112, which may be formed of any suitable material that is chemically and thermally stable at the operating parameters encountered in the vaporization region. Examples of suitable materials are oxidation resistant materials such as Hastelloy, Incoloy and Haynes alloys. Feed stream 16 is introduced at an inlet 114 of the conduit, which for example may be located or accessible from external steam reformer 100, and exits the vaporization region as a vaporized feed stream 16′ at the region's outlet 116. As discussed, vaporized feed stream 16′ is delivered to reforming region 36, which will typically have one or more inlets, as discussed in more detail subsequently. Accordingly, FIG. 7 demonstrates in solid lines that the vaporization region may have an outlet 116 proximate inlet 114, as measured relative to the central axis 140 of the reformer, and in dashed lines that region 110 may include an outlet 116′ distal inlet 114 relative to the central axis. It should be understood that the most desirable location for these components will tend to vary, such as depending upon the desired location of the vaporized feed stream relative to the inlet(s) to the reforming region. Similarly, the reformer may be configured so that the relative positions of the inlets and outlets described above may be reversed or otherwise oriented without departing from the scope of the disclosure.

As discussed previously, heating assembly 38 may include a burner, as indicated in dashed lines in FIG. 6 at 118. As used herein, “burner” is meant to broadly refer to a device that utilizes a combustible fuel stream to produce heat. In such an embodiment, the burner will produce a heated exhaust stream 120. As the size of reformer 13 is often relatively compact, the combustion of fuel stream 40 will often initiate in region 102 and continue in the combustion chamber 108. In such an embodiment, the combustion region and regions thereabout will often tend to be hottest away from ignition region 102. In FIG. 6, reformer 100 is shown including a heat-deflecting, or insulating, structure, 124 distal separation region 22 to reduce the amount of heat that is transferred to the separation region. In other words, an insulating layer, or heat shield, may be positioned between the combustion region and the separation region to reduce the extent to which the heating assembly heats the separation region. The material or materials from which structure 124 is formed are preferably selected to be thermally stable at the operating parameters encountered in combustion region 108, and to be able to sufficiently insulate the separation assembly to maintain the separation assembly at or below a selected temperature threshold, or at a selected temperature difference from the temperature in the combustion region proximate the separation assembly. Examples of a suitable material includes stainless steel, such as SS 304, SS 316, FeCrAlY, and oxidation-resistant alloys discussed above. The threshold temperatures for separation region 22 will tend to vary depending upon at least the type of separation structure utilized within region 22. For example, when palladium-copper hydrogen-selective membranes are used in separation region 22, it is preferable that the membranes not be heated above approximately 450° C., or in some embodiments 400° C., for extended periods of time, such as many hours or several days.

In embodiments of reformer 100 in which a heated combustion exhaust stream is used to heat the vaporization region to a selected operating temperature or range of temperatures, the temperature distribution within the combustion region will generally not be uniform. Instead, the temperature will tend to vary within the region, such as discussed above. To reduce the occurrence and/or severity of “hot spots” or localized regions of elevated temperature, within the combustion region and/or vaporization region, reformer 100 may, but does not necessarily, include a heat diffuser, or diffusion structure, 130. Structure 130 is adapted to reduce and/or dissipate these hot spots as heat is transferred from combustion region 108 to vaporization region 110. Illustrative examples of diffusers 130 are shown schematically in FIG. 6 and in a fragmentary view in FIGS. 7 and 8. Diffuser 130 is adapted to provide a more even temperature distribution to vaporization conduit 112 than if the diffuser was not present. Because the diffuser will conduct and radiate heat, hot spots will tend to be reduced in temperature, with the heat in hotter areas distributed to surrounding areas of the diffuser and surrounding structure. An example of a suitable material for diffuser 130 is FeCrAlY or one of the other oxidation-resistant alloys discussed above.

In embodiments of reformer 100 that include a diffuser 130, a suitable position for the diffuser is generally between the vaporization region and the heating assembly, as indicated in solid lines in FIGS. 6-8. The diffuser typically will extend at least substantially, if not completely, around the vaporization region and/or the heating assembly. Another suitable position for diffuser 130 is for the diffuser to surround the hydrogen-producing region, as schematically illustrated in dashed lines in FIGS. 6-8. It is also within the scope of the disclosure that one or more diffusers may be used, such as in an overlapping, spaced-apart and/or concentric configuration, including a reformer that includes both of the illustrative diffuser positions shown in FIGS. 6-8. In the illustrative configurations shown in FIGS. 6-8, the plurality of reforming catalyst beds may be described as collectively defining inner and outer perimeters, with the diffuser extending at least substantially around at least one of the inner and/or the outer perimeters of the plurality of reforming catalyst beds. Diffuser 130 should be formed from a material through which the combustion exhaust may pass. Examples of suitable materials include woven or other metal mesh or metal fabric structures, expanded metal, and perforated metal materials. The materials used should be of sufficient thickness or durability that they will not oxidize or otherwise adversely react when exposed to the operating parameters within reformer 100. As an illustrative example, metal mesh in the range of 20-60-mesh has proven effective, with mesh in the range of 40-mesh being preferred. If the mesh is too fine, the strands forming the material will tend to oxidize and/or will not have sufficient heat-conducting value to effectively diffuse the generated heat.

Continuing with the illustrative example shown in FIG. 5, the vaporized feed stream is delivered from vaporization region 110 to reforming region 36, in which mixed gas stream 20 is produced from the feed stream. In the illustrative embodiment, the reforming region may be described as extending around heating assembly 38, combustion chamber 108 and/or vaporization region 110. Although illustrated in FIGS. 5 and 6 as being concentrically located around vaporization region 110, it is within the scope of the disclosure that the shape and relative position of the reforming region may vary.

From reforming region 36, reformate stream 20 is delivered to separation region 22, as schematically illustrated in FIG. 5. As discussed, separation region 22 separates the reformate stream, which contains hydrogen gas and other gases, into a hydrogen-rich stream 24, which contains at least substantially hydrogen gas, and a byproduct stream 26, which contains at least a substantial portion of the other gases. In FIGS. 5 and 6, separation region 22 is shown including a schematically illustrated hydrogen-selective membrane 46. It is within the scope of the disclosure that more than one membrane 46 may be used. Examples of suitable hydrogen-selective membranes are described and incorporated above. Examples of suitable structures for separation region 22 are disclosed in U.S. Pat. Nos. 6,221,117 and 6,319,306, and U.S. patent application Ser. No. 10/086,680, the complete disclosures of which are hereby incorporated by reference for all purposes. As discussed, it is also within the scope of the disclosure that other separation structures and mechanisms may be used.

As discussed, steam reformers according to the present disclosure may also include a polishing region 48 in which hydrogen-rich stream 24 is further purified. An example of a reformer 100 that includes a polishing region is shown in FIG. 6. In this illustrative example, polishing region 48 is located external, or radially outward, from reforming region 36, vaporization region 110 and/or combustion chamber 108.

In FIG. 8, a schematic cross-sectional view of illustrative examples of suitable configurations for vaporization region 110, reforming region 36, and polishing region 48 are shown. In the lower right portion of FIG. 8, the regions are schematically illustrated as defining concentric bands that are located radially outward from the central axis 140 of the reformer. True, or complete, symmetry is not required by the present disclosure. However, the illustrated configuration has proven to perform well, in that the regions are operatively positioned for communication with each other and to obtain sufficient, but not excessive, heat from the heating assembly. Although it is within the scope of the disclosure, the respective regions will typically not extend as a solid boundary around heating chamber, or combustion region, 108. Instead, the regions will typically include one or more tubes in which the fluid streams flow, and where applicable, in which the catalysts are located. As used herein, a “tube” is meant to broadly refer to a conduit having an inlet and an outlet through which a fluid may flow. The cross-sectional and lengthwise configuration of the conduit may have any suitable shape and therefore may vary from those illustrated herein without departing from the scope of the disclosure. Typically, the tubes will be at least partially spread apart from each other.

In the lower left portion of FIG. 8, the reforming region is indicated generally at 36′, the polishing region is indicated generally at 48′, and the vaporization region is indicated generally at 110′. Reforming region 36′ includes a plurality of reforming tubes 142 that contain reforming catalyst 34. Reforming region 36′ may also be described as including a plurality of reforming catalyst beds (142) that contain reforming catalyst 34. Polishing region 48′ includes a plurality of polishing tubes 144 containing a methanation catalyst 52, a reforming catalyst 54, or other suitable filtering or purification structures, which are generally indicated at 146. Vaporization region 110′ includes a plurality of tubes through which the feed stream is passed and in which the stream is vaporized. The lower left portion also illustrates another example of a reformer that includes a combustion region 108 and at least one diffuser 130. The relative size of the regions may vary, and deviations from the illustrated radial configuration are still within the scope of the disclosure. To graphically illustrate this point, a polishing tube 144′ is shown in the lower left portion generally radially aligned with the reforming tubes 142. It is further within the scope of the disclosure that the number and relative size of the tubes may vary. To graphically illustrate this point, the upper portion of the reformer of FIG. 8 illustrates a reforming region 36″ and a polishing region 48″ with different numbers of tubes than in the lower left portion. The upper portion also illustrates a vaporization region 110″ that schematically represents tubes that extend generally circumferentially around the combustion region, or alternatively a vaporization region that is an open expanse, which may also be described as a conduit with an outer wall that is proximate the reforming region and an inner wall that is spaced radially inwardly from the outer wall and which surrounds the combustion region.

A benefit of the regions having a plurality of spaced-apart tubes is that heated fluid streams, such as combustion exhaust gases, may flow around the tubes and more easily reach, and therefore heat, regions of the reformer that are radially outward from the combustion region. To distribute a fluid stream through the tubes of a particular region, reformer 100 will typically include one or more distribution manifolds, which are adapted to receive a fluid stream, such as vaporized feed stream 16′, and to distribute the stream to the corresponding tubes, such as to reforming tubes 142. The reformer may additionally or alternatively include one or more collection manifolds, which are adapted to receive a plurality of similar, or like, fluid streams, such as the reformate, or mixed gas, streams from reforming tubes 142, and to merge these individual streams into one or more outlet streams, such as for delivery to separation region 22.

In FIGS. 9 and 10, examples of reformers 100 are shown that include distribution and collection manifolds 150 and 152 associated with reforming regions 36 and the corresponding reforming tubes 142. The distribution manifold receives the reforming feed stream and distributes the feed stream to the reforming tubes (or reforming catalyst beds), such as by delivering the feed stream to an end, end region or other input region of the tubes (or reforming catalyst beds). As discussed, in the tubes, a reformate (or mixed gas) stream containing hydrogen gas and other gases is produced. The collection manifold receives the reformate (or mixed gas) stream from the reforming tubes (or reforming catalyst beds), such as from an end, end region, or other outlet region thereof. For the purpose of simplifying these Figures, the reforming tubes have been schematically illustrated. The reforming tubes will typically, but not necessarily, be radially spaced apart from each other, such as to permit a heated fluid stream to pass between adjacent reforming tubes. Similarly, separation region 22 has been only very schematically illustrated, and the membranes or other separation structure, and the outlet(s) for hydrogen-rich stream 24 and byproduct stream 26 have not been illustrated in each of the embodiments.

In the left side of FIG. 9, reformer 100 is shown with a distribution manifold 150 that receives vaporized feed stream 16′ and distributes the feed stream to a plurality of reforming tubes 142 via a distribution conduit 154 that extends through the manifold and is in fluid communication with the reforming tubes. Also shown is a collection manifold 152 that includes a collection conduit 156 that is in fluid communication with the reforming tubes and thereby adapted to receive the reformate streams 20 leaving the reforming tubes. The collection conduit 156 is further in fluid communication with separation region 22 so that the hydrogen-rich stream may flow from the collection conduit into the separation region. As shown, collection conduit 156 may connect to separation region 22 via an internal (158) or external (160) linkage conduit.

In the illustrative embodiment depicted on the left side of FIG. 9, the distribution manifold is located at the end of the reforming tubes generally away from the separation assembly. However, to illustrate that this configuration is not required, the embodiment of reformer 100 shown on the right side of FIG. 9 includes distribution manifold 150 at the end of the reforming tubes that is proximate the separation assembly. In such a configuration, in which the reformate, or hydrogen-rich, stream 20 is collected at a collection manifold 152 that is at the end of the reforming tubes distal the separation assembly, stream 20 is delivered to the separation assembly via a linkage conduit, which as illustrated is external the reforming region. When selecting whether linkage conduits should, for a particular embodiment, be internal or external conduits, several competing factors may be considered. Internal conduits tend to produce, or at least enable, a smaller or more compact reformer. However, internal conduits tend to be more lo difficult to access. Therefore, when it is anticipated that the conduits may need to be accessed on a periodic, or more than infrequent basis, an external conduit may be preferred because it is more easily accessible. Described in another way, external conduits generally increase the overall size of the reformer, but are more easily accessed. For example, external conduits may include releasable fittings that enable the conduits, and any associated structure, to be fairly easily disconnected from the rest of the reformer and subsequently reattached thereto. Internal conduits 158 may additionally or alternatively be described as being integrated conduits that are not readily disconnected or removed from the corresponding portions of the reformer, while external conduits will tend to be selectively removed or disconnected from the corresponding portions of the reformer.

In FIG. 9, each of the generally parallel, radially spaced tubes in reforming region 36 contains a reforming catalyst. However, it is within the scope of the disclosure that at least one of these tubes may be used as an internal linkage conduit 158. Examples of steam reformers 100 that illustrate such a structure are shown in FIG. 10. For example, on the left side of FIG. 10, feed stream 16′ is delivered to an internal linkage conduit 158′. The stream travels generally toward the separation region to distribution manifold 152, where it is distributed and flows generally away from separation region 22 into a plurality of reforming tubes 142. The mixed-gas, or reformate, stream 20 produced in the reforming tubes is collected in collection manifold 152 distal separation region 22, and then transported to the separation region via another internal linkage conduit 158″. Still another example is provided on the right side of FIG. 10, in which feed stream 16′ enters an internal linkage conduit 158′ distal separation region 22 and flows toward the separation region to distribution manifold 150. The stream then flows generally away from the separation assembly in reforming tubes 142, and mixed gas stream 20 is collected in collection manifold 152 distal separation region 22. The mixed gas stream then flows to the separation region via an external linkage conduit 160.

In FIGS. 9 and 10, manifolds 150 and 152 have been illustrated as forming ring-like shapes that bound a central opening 162. It is within the scope of the disclosure, however, that the manifolds may not define central openings. For example, a manifold proximate separation assembly 22 may include a heat shield 124, such as indicated in FIG. 10. The opening 162 of the manifold distal separation region 22 will typically be present, with at least a portion of the heating assembly or combustion region extending therethrough. However, it is within the scope of the disclosure that both manifolds may be solid structures that do not define a central opening 162.

Also shown in dashed lines in FIGS. 9 and 10 at 164 are filter assemblies that are adapted to remove particulate, such as pieces of the reforming catalyst from mixed gas stream 20 prior to the stream being delivered to the separation assembly. Any suitable filter media 166 may be used. Examples lo include sintered metal tubes or other structures, porous ceramic materials, woven or non-woven metal mesh or screens, and the like. The filter media should be selected to be thermally and chemically stable when exposed to the operating parameters in conduit 160 and to the mixed gas streams. Filter media 166 with 2-5-micron pore diameter (or particle cutoff) have proven effective, but it is within the scope of the disclosure that other grades of media may be used and that reformer 100 may be formed without a filter assembly.

The reformers described and illustrated herein may be oriented in a variety of operating orientations, including a horizontal orientation, in which the reforming tubes extend generally parallel to a level ground surface and generally transverse to the direction at which gravity acts upon the reformer, and a vertical orientation, in which the reforming tubes extend generally transverse to a level ground surface and parallel to the direction at which gravity acts upon the reformer. Although both orientations are within the scope of the disclosure, a vertical orientation may be preferred in some embodiments because the reformer will tend to have thermal symmetry with respect to heating by a central burner and combustion chamber and/or symmetry with respect to gravity. As a further range of variations, in vertically oriented reformers, the reformer may be configured so that the vaporized feed stream flows generally upward (against gravity) or downward (with gravity). A benefit of having the vaporized feed stream flow generally upward is that there will tend to be reduced channeling in the reforming tubes. When channeling occurs in a catalyst tube, the flow of gas through the tube produces passages that are free from catalyst, and gases flowing through these passages will be less likely to react, or fully react, as in a more compact tube in which the channeling has not occurred.

In operation, reforming region 36 will typically be heated to an operating temperature in the range of approximately 200-800° C. (for instance, when measured at the central axis of the reforming tubes). When the carbon-containing feedstock is methanol, the reforming temperature will tend to be in the range of 200-400° C., preferably in the range of approximately 350-400° C., and more preferably in the range of 375-400° C. Typically, the vaporized feed stream will be delivered to the reforming region at a pressure of at least 50 psi and less than 300 psi. In experiments, a pressure of 100-200 psi has proven effective. In the case of methanol reformers, the vaporized feed stream is typically heated to a temperature that is greater than the selected reforming temperature, and preferably is at least 50 or 100° C. greater than the selected reforming temperature. The temperature of the vaporized feed stream will typically not be heated more than 300° C. above the selected reforming temperature, and in the case of reformers that receive a feed stream containing hydrocarbons and/or other alcohols, it is preferable that the feed stream not be superheated. The operating parameters described above have been presented for the purpose of illustration and not limitation, and therefore should not be construed as an exclusive list or range of acceptable operating parameters within the scope of the disclosure.

Another steam reformer (steam reforming fuel processor) constructed according to the present disclosure is shown in FIGS. 11-15 and generally indicated at 200. It is within the scope of the disclosure that reformer 200 may be used in any of the fuel processing or fuel cell systems described, illustrated and/or incorporated herein and reformer 200 may include any of the elements, subelements and variations described, illustrated and/or incorporated herein. For the purposes of brevity, elements of 200 that are the same as previously described elements will not be described again, but it is within the scope of the disclosure that these elements, as present in reformer 200, may have any of the subelements and variations previously described, illustrated and/or incorporated. Similarly, the other reformers and fuel processors described, illustrated and/or incorporated herein may also include the elements described and/or illustrated with respect to reformer 200.

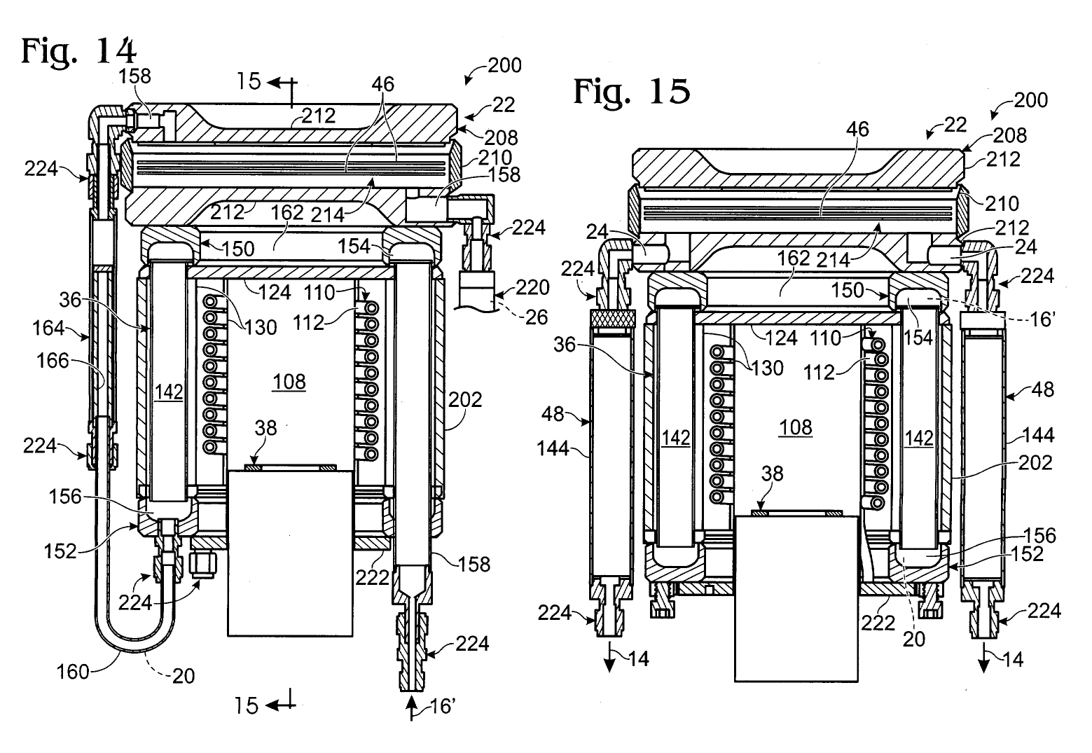

As perhaps best seen in FIGS. 14 and 15, reformer 200 is similar in construction to the reformer 100 shown on the right side of FIG. 10. With reference to FIGS. 11-15, it can be seen that feed stream 16 is delivered to inlet 114 of the vaporization conduit, or coil, 112 defining vaporization region 110. The vaporized feed stream 16′ flows through internal linkage conduit 158 to a distribution manifold 150 that is proximate separation region 22. The vaporized feed stream is distributed via distribution conduit 154 to reforming region 36, which includes a plurality of radially spaced apart reforming tubes 142 that contain reforming catalyst 34. In FIGS. 11-15, the reformer includes a form of heat diffuser in the form of a thermal insulating layer, or heat deflector, 202 that extends around reforming region 36. As layer 202 is heated by heating assembly 38, such as by combustion exhaust gases, the layer radiates the heat back to the reforming tubes and associated components of the reformer, thereby recovering some of the heat that otherwise would have been dissipated from the reformer. Although layer 202 is not required, it will typically reduce the amount of heating required to maintain the reformer at a selected operating temperature. Layer 202 will typically not form a fluid-tight seal around the reforming region. Instead, it will often be formed from a porous, mesh or otherwise air-permeable material through which the exhaust gases may flow.

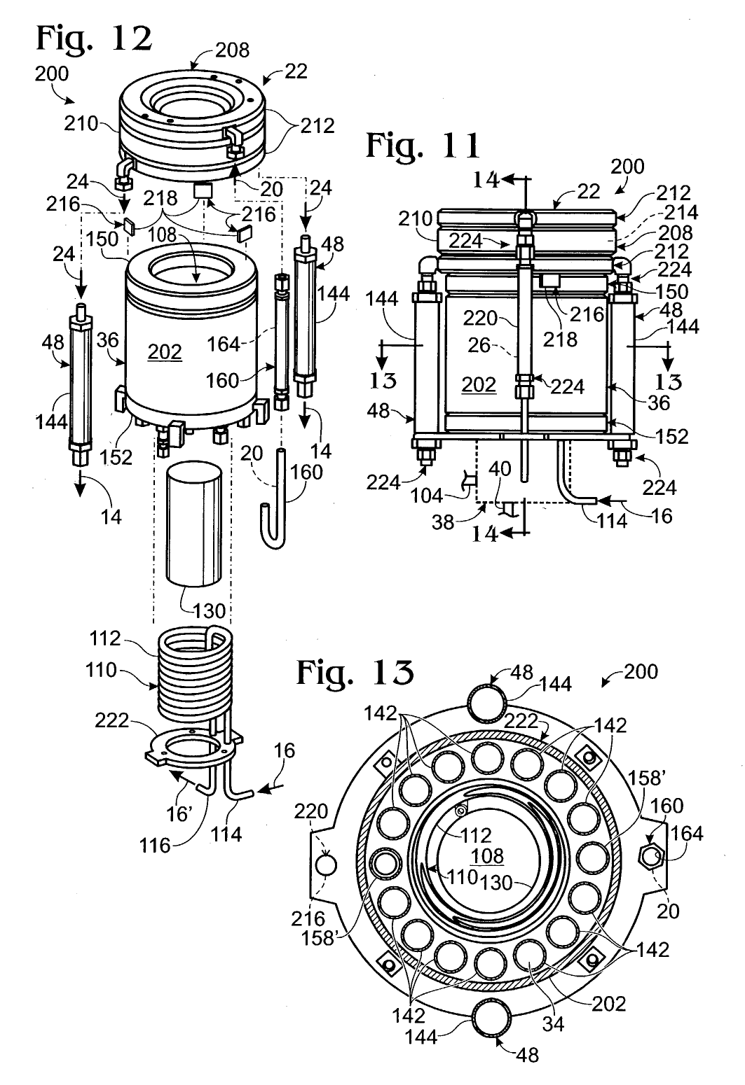

The reformate stream 20 produced in the reforming tubes is collected in collection manifold 152 distal separation region 22 and then delivered to separation region 22 via an external linkage conduit 160 that optionally contains filter assembly 164. In the illustrated embodiment, the separation region includes an enclosure 208 that defines an internal compartment 214, which contains at least one hydrogen-selective membrane 46 or other suitable separation structure. Enclosure 208 is preferably a fluid-tight compartment, and as illustrated includes a shell 210 and a pair of end plates 212. As perhaps best seen in FIGS. 11 and 12, reformer 200 includes a flange assembly 216 that is adapted to retain the separation region and the reforming region together. In the illustrated embodiment, the flange assembly includes a plurality of radially spaced apart members 218; however, it is within the scope of the disclosure that the flange assembly may extend completely around the separation and reforming regions. As an additional or alternative variation, the separation and reforming regions may be otherwise secured together, such as by a fixed fastening mechanism, such as welding, or by a selectively releasable mechanism, such as a threaded interconnection or a releasable strap or band. As yet a further variation, the flange assembly may be welded to one or both of the separation and reforming regions.

Returning to FIG. 14, it can be seen that byproduct stream 26 is delivered, such as via an internal linkage conduit 158 in enclosure 208, to a byproduct conduit 220. Conduit 220 may be in fluid communication with a burner, including heating assembly 38, an exhaust vent, a storage device and/or a device adapted to consume the byproduct stream. As shown in FIG. 15, other internal linkage conduits deliver hydrogen-rich streams 24 to polishing region 48, which as shown includes a pair of polishing tubes 144 and in which product hydrogen stream 14 is produced. Similar to many of the previously described embodiments, reformer 200 includes a heating assembly 38, which is schematically illustrated extending at least partially beneath a base plate, or mount, 222 and which is in communication with combustion region, or heating chamber, 108. As perhaps best seen in FIG. 13, mount 222 also engages, or provides a support for, polishing tubes 144 and external linkage conduit 160. It is within the scope of the disclosure that reformer 200 optionally may be formed without base plate 222 and/or with a base plate that does not provide such a support.

In FIGS. 14 and 15, further illustrative examples of suitable configurations for vaporization conduit 112, heat shield 124, and diffuser 130 are shown. Also shown in at least FIGS. 14 and 15 are various fittings 224 that are selectively releasable to facilitate disconnection of various components of the steam reformer, such as for cleaning, maintenance, replacement, access to internal components, etc. Although threaded fittings have been shown in FIGS. 11-15, it is within the scope of the disclosure that any other suitable selectively releasable fitting may be used. It is also within the scope of the disclosure that some, if not all, of the fittings may be removed, in which case the corresponding components will tend to be fixedly permanently secured together, such as by welding, or integrally formed with each other.

The amount of reforming catalyst to be used in a particular reformer will vary, such as depending upon the capacity of the reformer to accept the reforming catalyst, as well as the composition and structure of the catalyst and the desired flow rate of feed stream 16 and/or product hydrogen stream 14. For purpose of illustration, consider an embodiment of reformer 200 having a diameter of approximately 6 inches and a height (measured from base plate 222 to the top of separation region 22) of approximately 10 inches. In such an embodiment, reforming tubes having a diameter of approximately ⅝-¾ inches have proven effective, with approximately 600 grams of reforming catalyst 34 collectively contained within the reforming tubes. When feed stream 16 contains methanol and water and is delivered at feed rates of 10 mL/min-70 mL/min, the reformer produces a product hydrogen stream 14 at rates in the range of 2 L/min-55 L/min.

Accordingly, the above example demonstrates that reformer 200 has a relatively compact design. Less compact embodiments are also within the scope of the disclosure, as well as embodiments that have been scaled up or down, such as to produce larger or smaller flow rates of product hydrogen stream 14. Similarly, varying the dimensions of the reforming tubes and/or the amount of reforming catalyst will also affect the size and/or capacity of reformer 200.

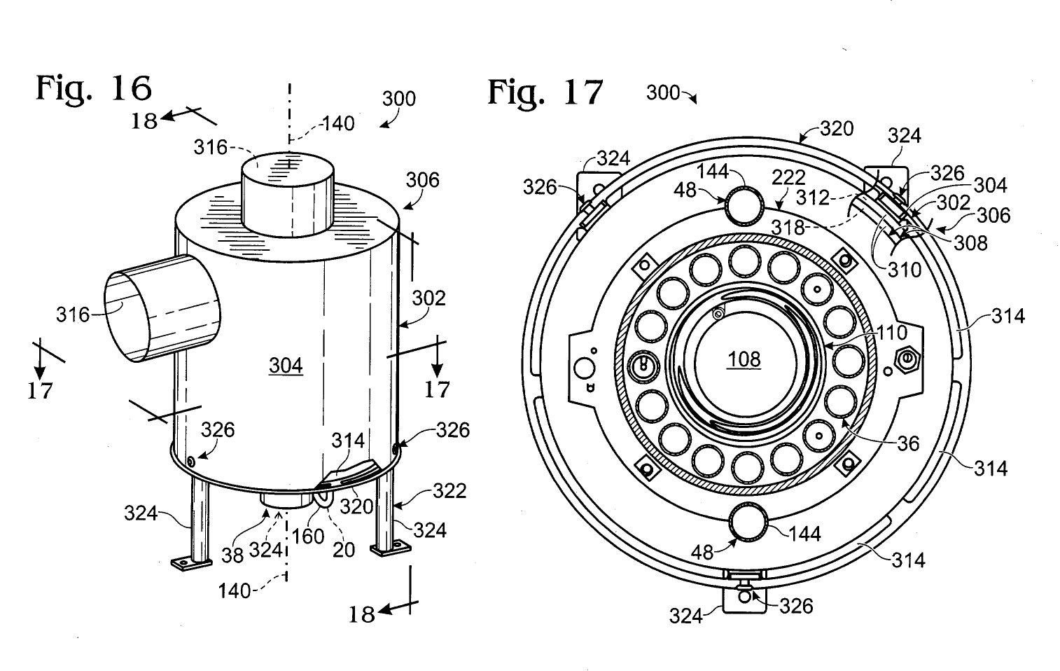

Another steam reformer constructed according to the present disclosure is shown in FIGS. 16-19 and indicated generally at 300. It is within the scope of the disclosure that reformer 300 may be used in any of the fuel processing or fuel cell systems described, illustrated and/or incorporated herein, and that reformer 300 may include any of the elements, subelements and variations described, illustrated and/or incorporated herein. For the purposes of brevity, elements of reformer 300 that are the same as previously described elements will not be described again, but it is within the scope of the disclosure that these elements, as present in reformer 300, may have any of the subelements and variations previously described, illustrated and/or incorporated. Similarly, the other reformers and fuel processors described, illustrated and/or incorporated herein may also include the elements described and/or illustrated with respect to reformer 300.

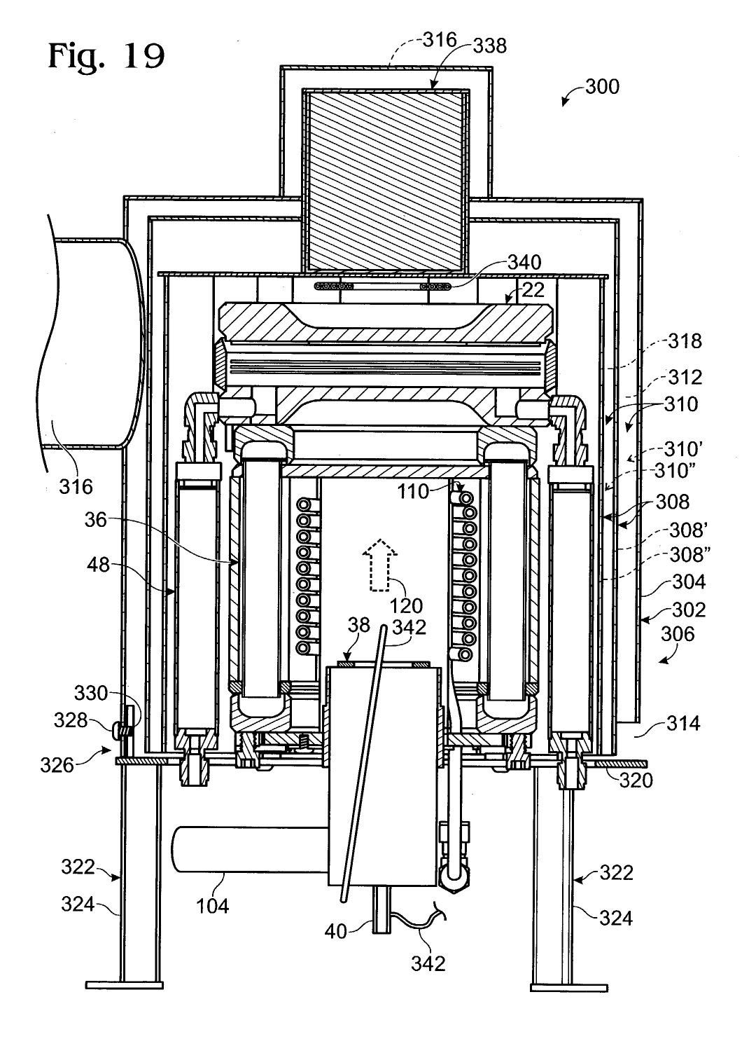

Reformer 300 includes a shell, or shroud, 302 that has an outer, or external, surface 304 and which forms a portion of an insulating structure 306 that is adapted to reduce the temperature of surface 304 relative to reforming region 36, and preferably, to maintain surface 304 at a temperature of 50° C. or less. As perhaps best seen in FIGS. 17-19, structure 306 includes at least one interior shell 308 that is spaced apart from at least the exterior surface to define a passage 310 extending there between. In the illustrated embodiment, the insulating structure includes a pair of spaced-apart layers, or interior shells, 308′ and 308″ that respectively define passages 310′ and 310″. Passages 310 may be sealed, or may include at least one inlet and outlet through which a fluid 312, such as air, may flow. For example, and for the purpose of illustration, in FIG. 19, passage 310′ is shown as a hollow passage that is in fluid communication with at least one inlet 314 and at least one outlet 316 that enable air to be drawn through the passage to cool the exterior surface 304 of the reformer. For example, the reformer may include and/or be in fluid communication with a cooling assembly that is adapted to urge a cooling fluid stream through the passage. An illustrative, non-exclusive example of a suitable cooling assembly is a fan, blower, compressor or other air-delivery assembly that is adapted to blow or draw an air stream through the passage.

In the illustrative embodiment, outlet 316 extends generally radially outward from the central axis of the reformer. However, it is within the scope of the disclosure that outlet 316 may be located and/or oriented elsewhere on shell 302 or the subsequently described base 320, such as indicated in dashed lines in FIG. 19. As perhaps best seen in FIG. 17, base 320 may include additional inlets 314 to the passage(s). In embodiments of reformer 300 in which the heating assembly produces a heated exhaust stream 120, this stream may be mixed with the flow of air introduced by inlet(s) 314 to cool the heated exhaust stream prior to emitting the stream from the reformer. Alternatively, it may be desirable in some embodiments to remove the heated exhaust stream without intentionally cooling the stream, such as to use the stream for additional heat exchange external the reformer.

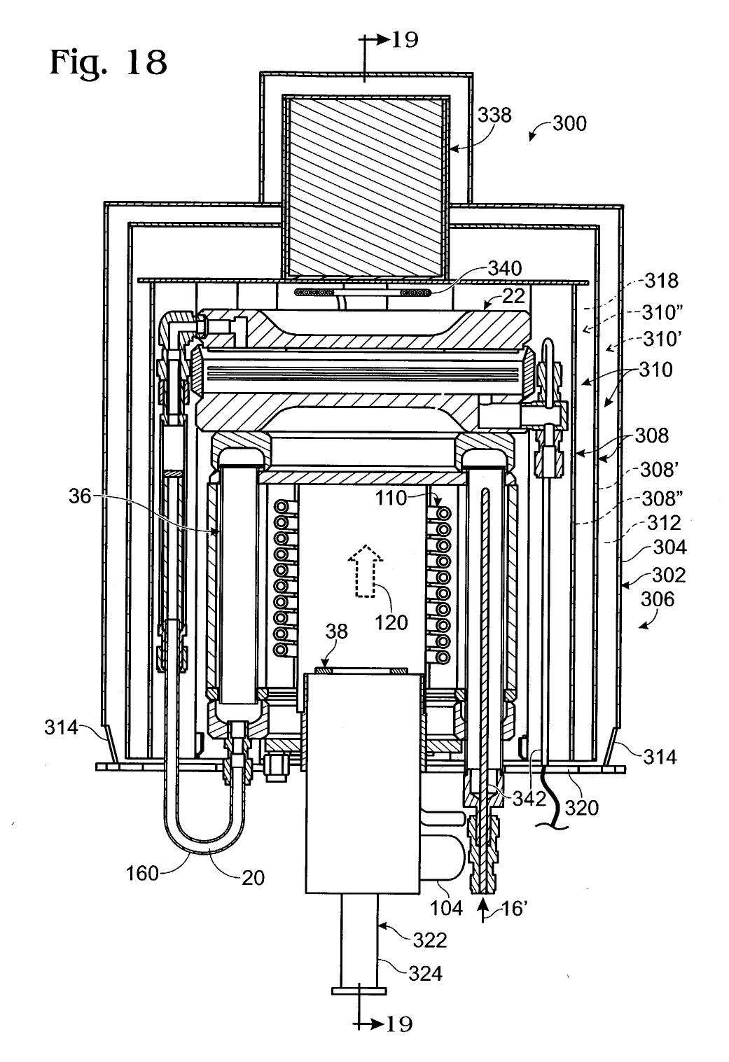

An example of a mechanism for drawing air through the passage is a fan that either blows air into passage 310′ via inlet(s) 314 or draws air from passage 310′ via outlet(s) 316. Another example is a blower or a source of pressurized air that urges air through the passage. Additionally or alternatively, at least one of the passages may be at least partially filled with a solid insulating material, such as blanket insulation, a foamed insulating material, a solid ceramic insulating material, and the like. For the purpose of illustration, solid insulating material is schematically illustrated in dash-dot lines in FIGS. 18-19 at 318 in passage 310″. It is within the scope of the disclosure that the number and relative dimensions of the shells may vary. In embodiments having the dimensions described above, an insulating structure with the illustrated relative dimensions produces an exterior shell with a diameter of approximately 11 inches.

Also shown in FIGS. 17-19 is a base 320 to which shell 302 is secured. It is within the scope of the disclosure that the shell may be fixedly secured to the base, meaning that it is welded or otherwise secured so that the base and shell cannot be readily disconnected and reconnected relative to each other. However, shell 302 will typically be releasably secured to base 320, such as by fasteners 326, which may take any suitable form. In the illustrated example, the fasteners include a screw, pin, bolt or other insertable member 328 that is selectively passed through shell 302 and into a receiver 330 to couple the shell to the base.

As discussed previously, reformers according to the present disclosure may be oriented for use in a variety of operating configurations, including a vertical configuration. As also discussed and illustrated herein, at least some of the components of the reformer may project through the base and away from the reforming region. In a vertically oriented reformer, these components may be described as extending beneath base 320. Accordingly, in such an embodiment, it may be desirable for reformer 300 to include a stand or other suitable support structure 322. In FIGS. 18 and 19, stand 322 is shown including a plurality of legs 324, but any suitable supporting structure may be used. Similarly, in horizontally oriented embodiments of the reformers or in embodiments in which components do not extend beneath base 320, the stand may be omitted.

In FIGS. 18 and 19, it can be seen that reformer 300 includes a catalytic converter 338 that is adapted to reduce the combustion byproducts, such as carbon monoxide, in the heated exhaust stream 120 from the heating assembly. Although it is within the scope of the disclosure that reformer 300 may be formed without converter 338, converter 338 may be desired when the reformer is used in an enclosed, or indoors environment or in an environment that is subject to emissions standards, such as many industrial environments. It is within the scope of the disclosure that any other suitable form of exhaust filter may be used in place of converter 338, and as discussed, that reformers may be formed without converter 338 or an exhaust filter.

Also shown in FIGS. 18 and 19 is an optional evaporator 340 that is adapted to vaporize any residual liquid-water content in exhaust stream 120. In many embodiments, evaporator 340 will not be necessary. However, in some embodiments, additional fluid streams are mixed with the exhaust stream 120 external reforming region 36 to reduce the temperature of the resulting stream. As an example, the cathode air exhaust from a fuel cell stack may be mixed with stream 120. This air exhaust stream has a vapor pressure of water that exceeds the stream's saturation point. Accordingly, it contains a mixture of liquid water and water vapor. To prevent water from condensing or otherwise depositing within the reformer, such as on separation region 22, evaporator 340 may be used.

Reformers according to the present disclosure will often be in communication with a controller that regulates the operation of the reformer, such as to shut down or otherwise control the operation of the reformer if the reformer is not operating within predetermined threshold values. An example of a suitable controller for a steam reforming fuel processor is disclosed in U.S. Pat. No. 6,383,670, the complete disclosure of which is hereby incorporated by reference for all purposes. Accordingly, the reformers may include various sensors 342, such as temperature sensors, pressure sensors, flow meters, and the like, of which several illustrative examples are shown in FIGS. 18 and 19.

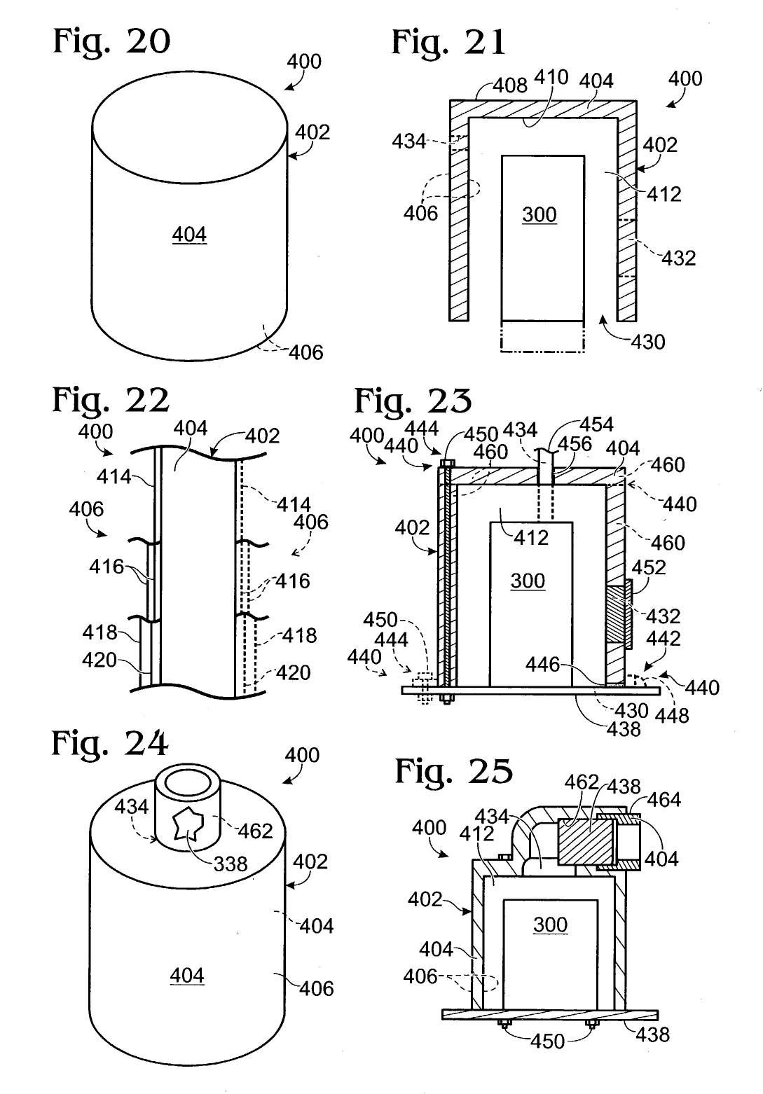

Another example of a suitable shell, or shroud, for fuel processors that operate at elevated temperatures, such as the steam reforming fuel processors disclosed herein, is shown in FIGS. 20-21 and generally indicated at 400. Shell 400 includes a body 402 that is formed from a ceramic material, and preferably from a refractory ceramic material 404. Refractory ceramic materials are porous materials that are made from mechanically interlocked fibers that are formed from such materials as alumina, silica, zirconia and the like. A benefit of refractory ceramic materials is that they are comparatively light and inexpensive compared to multi-layer metal shrouds. Refractory ceramic materials also have low thermal conductivity and therefore are adapted to not conduct heat from the reformer or its exhaust gases through the shell. Consider, for example, that a reformer which is heated to approximately 500° C. will typically require not only a multi-layer metal shroud but also a coolant system (such as forced air or other fluid) to maintain the outer surface of the shroud below a desired temperature, such as below 50° C. While effective, this metal shroud tends to be heavy and expensive to produce, in addition to its additional cooling requirements.

However, unlike metal shrouds, refractory ceramic materials tend to be porous and therefore permeable to the exhaust gases from a reformer or other fuel processor. Accordingly, when the reformer or other fuel processor housed within the shell emits combustion or other exhaust gases, the shell should include a coating 406 that is impermeable to the exhaust gases produced by the reformer (or other fuel processor). Coating 406 is applied to at least one of the inner and outer surfaces of the shell, as graphically indicated in FIGS. 20 and 21 in dashed lines.

As shown in FIG. 21, shell 400 includes inner and outer surfaces 408 and 410, with the inner surface defining an internal compartment 412 within which a fuel processor is housed. In the illustrative embodiment shown in FIG. 21, reformer 300 is shown housed within the shell, but it is within the scope of the disclosure that shell 400 may be sized or otherwise adapted to house any of the steam reformers and other fuel processors disclosed, illustrated and/or incorporated herein. In FIG. 21, compartment 412 is sized to define an air boundary, or pocket around the reformer. However, and as discussed in more detail herein, it is within the scope of the disclosure that the shell may be sized to conform to the more particular shape of the particular reformer or other fuel processor to be housed within the shell.

Coating 406 is selected to be impermeable to the exhaust gases produced or otherwise emitted from the reformer. Furthermore, coating 406 should be selected to be thermally and chemically stable at the operating temperatures and in the operating environment encountered during use of the steam reformer (or other fuel processor). For example, the outer surface of the shell preferably will not exceed 100° C. and more preferably will not exceed 70° C., or even 50° C. The inner surface of the shell is likely to be exposed to higher temperatures, such as temperatures of at least 200° C. and often temperatures in the range of 400° C.-1000° C. or more. The particular temperatures encountered within the shell will tend to vary with such factors as the degree (if any) of cooling provided within the shell, such as by a cooling fluid, the operating temperature of the reformer, the amount of heat exchange occurring within the reformer, etc. For example, in the context of a coating for the outer surface of a shell to be used on a steam reforming fuel processor, a high-temperature silicone coating has proven effective. A coating 406 formed from a room temperature vulcanized silicone rubber has also proven effective. Because the porous refractory ceramic material is coated on one or both of its surfaces with a coating that is impermeable to the exhaust gases from the reformer, the coated shell provides an exhaust gas-impermeable housing for the reformer or other fuel processor. As discussed in more detail herein, the impermeability of the coated shell, coupled with the low thermal conductivity of the refractory ceramic material, enables the shell to contain the heat from the reformer and its exhaust gases and to route, or channel, this heat to a desired output.

Coating 406 may be applied to the ceramic material via any suitable mechanism, such as spraying, painting, dipping, etc. The thickness and number of layers (coats) of the coatings may vary within the scope of the disclosure, and may tend to be affected by such factors as the anticipated temperature at which the coating will be used, the composition and thickness of the ceramic material from which the shell is formed, the surface (or portion thereof) to be coated, etc. In experiments, a coating thickness in the range of approximately 0.5-6 millimeters has proven effective to provide a gas-impermeable ceramic shell, but it is within the scope of the disclosure that thicker and thinner layers of coating 406 may be used. It is also within the scope of the disclosure that more than one layer of coating and/or more than one composition of coating may be used. When coatings having different compositions are used in an overlapping configuration, the coatings should be selected to be either unreactive, or favorably reactive, with each other. In other words, any interaction between the coatings should preferably not inhibit or otherwise reduce the gas-impermeability of the shell. Coatings having different compositions also may also applied to different regions of a surface and/or on different surfaces of the shell.

Graphical, somewhat schematic illustrations of many of the above options are shown in FIG. 22. As shown, a single layer 414 of a coating is shown in solid lines on a first (such as the inner or outer) surface of the shell. A layer 414 of the same coating is shown on the opposed surface of the shell and indicated in dashed lines to graphically depict that only one of the surfaces may be coated or that the same coating may be applied to both surfaces of the shell. At 416, two overlapping layers of the same coating are shown to graphically demonstrate that the selected coating may be applied in more than one layer, or coat. At 418 and 420, two overlapping layers of coatings having different compositions are shown to graphically depict that more than one composition of coating may be used.

The body 402 of shell 400 may be formed through any suitable method for forming articles from refractory ceramic materials. A process that has proven effective is a vacuum forming process. In a vacuum forming process, a perforated mold is placed into a slurry of the ceramic material 404 from which the body is to be formed. A vacuum is placed on the inside of the mold and used to draw moisture from the slurry through the perforations in the mold. As this occurs, the ceramic fibers in the slurry accumulate on the outer surface of the mold. After a desired thickness of fibers have accumulated on the mold, the mold is removed from the slurry, and then the produced article is removed from the mold and dried or otherwise cured. After formation, the ceramic article can be milled, drilled, cut or otherwise machined, if necessary, to a desired final shape. Although a vacuum forming process may be used to make standardized shapes, such as boards and cylinders, it also offers the benefit of being useful to produce more complex shapes, such as may be defined by a more complex mold and/or the final machining of the process.

As somewhat schematically illustrated in FIG. 21, shell 400 encloses reformer 300 from all but one side, with the bottom surface of the reformer not enclosed by the shell in FIG. 21. It is within the scope of the disclosure that at least a portion of the reformer or other fuel processor may extend outside of the compartment 412 defined by shell 400. This is graphically depicted in dashed lines in FIG. 21. It is also within the scope of the disclosure that shell 400 may completely enclose the reformer; however, this construction requires that the shell be formed from at least two ceramic components that are secured together after placement of the reformer into the compartment 412 defined thereby. It is also within the scope of the disclosure that shell 400 only partially encloses the reformer, such as by extending around the perimeter of the reformer (but not the top or bottom), by extending around the perimeter (but only a portion of at least one of the top and/or bottom of the reformer), by substantially enclosing the reformer except for an opening through which the reformer may be accessed, etc. When the shell defines an opening, such as indicated at 430 in FIG. 21, the opening may be sufficiently large for the reformer to be selectively removed from and replaced into the shell's compartment.

The shell may include more than one opening, such as to include an opening that is too small for the reformer (or other fuel processor) to be removed from the compartment therethrough, but which is sufficiently large for the reformer to be accessed by a user, such as for maintenance, adjustment, servicing, and/or repair. Such an opening is graphically depicted in dashed lines in FIG. 21 at 432. As a further variation, the shell may include one or more openings that define inlets or outlets from the compartment. The inlets may be used to deliver fluids into the compartment, such as for cooling within the compartment and/or for delivery to the reformer, as well as for communication linkages to the reformer or compartment. For example, the communication linkages may establish communication from external the shell with various sensors and/or flow control devices within the compartment (including within the reformer). The outlets may be used to exhaust fluids from the reformer and/or from the compartment. An illustrative example of such an opening is graphically depicted in dashed lines at 434 in FIG. 21.

Openings in the shell will typically include a cover or conduit associated therewith so that heat within the compartment may not freely exit the shell to the environment. For example, an opening that is designed as an exhaust port for gases within the compartment may be coupled to an exhaust conduit that receives these hot exhaust gases. As another example, an opening that is designed to provide selective access to the compartment, such as for removal or servicing of the reformer, may include a cover that is designed to be selectively and repeatedly removed and replaced relative to the opening. The cover may be formed from any suitable material, including a refractory or other ceramic material, insulating and/or metallic materials. As yet a further example, an opening that is used to establish communication linkages and/or receive a fluid-flow conduit may include sealing material to prevent gases within the compartment from exiting the compartment through the opening around the communication linkage or flow conduit.

In FIG. 23, various illustrative examples of openings that may be used with a refractory ceramic shell 400 are shown for the purpose of graphical illustration. However, and as discussed, the number and type of openings (and/or associated covers/plugs/seals) may vary within the scope of the disclosure. At 438, a cover plate is shown that provides a mount for reformer 300 and to which the shell is secured by a suitable fastening mechanism 440. Alternatively, reformer 300 (or any other fuel processor) may be secured to the shell, with plate 438 being secured to the reformer and/or shell to enclose the reformer within the compartment. Examples of suitable fastening mechanisms 440 include permanent fastening mechanisms 442 and releasable fastening mechanisms 444. By “permanent fastening mechanisms,” it is meant mechanisms such as adhesives 446 and welds 448 that cannot be released without destruction of at least the fastening mechanism. By “releasable fastening mechanisms,” it is meant bolts, clamps and other mechanical fasteners 450 that are designed to be repeatedly secured and released without destruction of the fastening mechanism. Also shown in FIG. 23 is an illustrative example of an access-port sized opening 432 that includes a cover 452 and an opening 434 that is in fluid communication with a fluid flow conduit 454 (such as for delivery or removal of fluid into or out of the compartment and/or into or out of the reformer or other fuel processor) and optional sealing material 456. The covers (and cover plates) described herein may be formed from any suitable material, such as metal or a ceramic material.

In FIG. 23, the relative size of shell 400 relative to reformer 300 differs from FIG. 21 to graphically demonstrate that the relative size of the shell may vary within the scope of the disclosure relative to the reformer or other fuel processor that is received within the shell. Accordingly, the shell may be specifically dimensioned to receive a particular fuel processor, such as with the shell being molded to generally conform to the dimensions of the fuel processor, or the shell may be sized to define a compartment that is sufficiently large to receive a variety of sizes and/or dimensions of fuel processors therewithin.

The ceramic body 402 of shell 400 may be formed as a unitary structure or it may be formed from two or more halves or other discrete components that are secured together by a suitable fastening mechanism 440. This is graphically depicted in FIG. 23, in which a unitary ceramic shell is shown in solid lines, and in dashed lines in which shell 400 is formed from a plurality of separately formed ceramic components 460. When shell 400 is formed from more than one ceramic component, these components may take a variety of shapes, such as each component forming a half of the final shell, one component sized to surround the sides of the reformer and at least one other component sized to enclose an end of the reformer, etc.

In FIG. 24, an example of a shell 400 is shown that includes an opening 434 with a catalytic converter 338 or other suitable filter adapted to filter the gases passing through the shell. It is within the scope of the disclosure that converter 338 is releasably or permanently secured to the shell. It is also within the scope of the disclosure that the converter is coupled to the reformer or other fuel processor and not directly secured to the shell. When the converter is releasably or permanently secured to the shell, it may be desirable for the shell to be molded or otherwise shaped to define a mount 462. In FIG. 25, an example of a shell that is formed from at least two discrete ceramic components is shown, with these components including a ceramic exhaust port 464 that is secured to the main body of the shell and which retains converter 338 within the shell. In FIGS. 24 and 25, openings 434 are shown extending out of the side and top surfaces of the shell, respectively, to graphically illustrate that the openings, if present in a particular embodiment of the shell, my extend from various positions on the shell. It is also within the scope of the disclosure that the openings may extends from a base plate or cover plate that is coupled to the shell.

### Industrial Applicability

Steam reformers and other fuel processors according to the present disclosure are applicable to the fuel processing, fuel cell and other industries in which hydrogen gas is produced, and in the case of fuel cell systems, consumed by a fuel cell stack to produce an electric current.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A steam reforming fuel processor, comprising:
a heating assembly that includes an ignition region and which is adapted to introduce a heated exhaust stream into a combustion region, wherein the combustion region includes a first portion that is generally proximate the ignition region and a second portion that is distal the ignition region;
a vaporization region adapted to receive a reforming feed stream comprising water and at least one carbon-containing feedstock and to form a vaporized feed stream therefrom, wherein the vaporization region is positioned to extend within the combustion region and/or extend around the combustion region;
a reforming region containing a plurality of vertically oriented reforming catalyst beds, wherein each reforming catalyst bed includes an inlet region adapted to receive the vaporized feed stream and to produce a reformate stream containing hydrogen gas and other gases therefrom, and an outlet region adapted to exhaust the reformats stream, wherein the plurality of reforming catalyst beds are generally symmetrically and radially spaced relative to the combustion region, define an axis extending at least generally parallel to the plurality of reforming catalyst beds, and extend radially outward from the vaporization region relative to the axis;
a distribution manifold adapted to receive the reforming feed stream and to distribute the reforming feed stream to the inlet regions of the reforming catalyst beds;
a collection manifold adapted to receive the reformate stream from the outlet regions of the reforming catalyst beds, wherein the collection manifold is in fluid communication with a separation region;
a separation region proximate the second portion of the combustion region and adapted to receive the reformate stream and to produce a hydrogen-rich stream containing at least substantially pure hydrogen gas and a byproduct stream containing at least a substantial portion of the other gases, wherein the separation region includes an enclosure containing at least one hydrogen-selective membrane and into which the reformate stream is introduced, with the hydrogen-rich stream being formed from a portion of the reformate stream that passes through the at least one hydrogen-selective membrane and the byproduct stream being formed from a portion of the reformats stream that does not pass through the at least one hydrogen-selective membrane, wherein the at least one hydrogen-selective membrane extends generally transverse to the axis extending at least generally parallel to the plurality of reforming catalyst beds; and
at least one methanation catalyst bed containing a methanation catalyst and adapted to receive the hydrogen-rich stream and to reduce the concentration of any carbon monoxide present in the hydrogen-rich stream.

2. The fuel processor of claim 1, wherein at least one of the distribution and the collection manifolds is an annular manifold that defines a central opening through which a portion of the heating assembly extends and/or through which the heated exhaust stream flows.

3. The fuel processor of claim 2, wherein both of the distribution and collection manifolds are annular manifolds that define a central opening through which a portion of the heating assembly extends and/or through which the heated exhaust stream flows.

4. The fuel processor of claim 1, wherein the distribution manifold is positioned proximate the ignition region of the heating assembly and the collection manifold is positioned distal the ignition region of the heating assembly relative to the distribution manifold, and further wherein the distribution manifold is adapted to deliver the vaporized feed stream to the plurality of reforming catalyst beds such that the vaporized feed stream flows through the plurality of reforming catalyst beds generally toward the ignition region.

5. The fuel processor of claim 1, wherein the plurality of reforming catalyst beds collectively define an inner perimeter and an outer perimeter, and further wherein the fuel processor includes at least one heat diffusion structure that extends at least substantially around at least one of the inner and the outer perimeters of the plurality of reforming catalyst beds.

6. The fuel processor of claim 5, wherein the heat diffusion structure is formed from a thermally conductive material that is permeable to the heated exhaust stream and resistant to oxidation.

7. The fuel processor of claim 1, wherein the fuel processor further includes a heat-deflecting structure that extends generally between the second portion of the combustion region and the enclosure that contains the at least one hydrogen-selective membrane.

8. The fuel processor of claim 1, wherein the at least one methanation catalyst bed extends generally parallel to the plurality of reforming catalyst beds.

9. The fuel processor of claim 8, wherein the at least one methanation catalyst bed is positioned radially outward from the plurality of reforming catalyst beds relative to the axis.

10. The fuel processor of claim 8, wherein the at least one methanation catalyst bed is concentrically positioned with the plurality of reforming catalyst beds relative to the axis.

11. The fuel processor of claim 1, wherein the fuel processor further includes at least one fluid transfer conduit extending generally parallel and concentric with the plurality of reforming catalyst beds relative to the axis.

12. The fuel processor of claim 1, wherein the fuel processor further includes at least one filter assembly extending between the collection manifold and the enclosure that contains the at least one hydrogen-selective membrane.

13. The fuel processor of claim 1, further comprising a shell that defines a compartment within which at least the reforming region, at least a substantial portion of the combustion region, and the enclosure are enclosed.

14. The fuel processor of claim 13, wherein the shell is formed from a plurality of spaced-apart metal layers that are separated by insulating structure.

15. The fuel processor of claim 14, wherein the insulating structure includes at least one hollow passage having an inlet and an outlet, and further wherein the fuel processor is in fluid communication with a cooling assembly that is adapted to urge a cooling fluid stream through the at least one hollow passage.

16. The fuel processor of claim 13, wherein the shell includes a body formed from a refractory ceramic material, wherein the body includes an inner surface and an outer surface, and further wherein at least one of the inner and the outer surfaces include a coating that is impermeable to the heated exhaust stream.

17. The fuel processor of claim 16, wherein the heated exhaust stream that contacts the inner surface of the body has a temperature of at least 400° C., and further wherein the shell is adapted to prevent the outer surface of the body from being heated above a temperature of 60° C. by the heated exhaust stream.

18. The fuel processor of claim 13, wherein the shell includes at least one outlet through which the heated exhaust stream is exhausted from the shell.

19. The fuel processor of claim 18, further comprising an exhaust filter through which the heated exhaust stream passes prior to being exhausted from the shell.

20. The fuel processor of claim 19, wherein the exhaust filter includes a catalytic converter.

21. The fuel processor of claim 19, wherein the exhaust filter is coupled to the at least one outlet through which the heated exhaust stream is exhausted from the shell.

22. The fuel processor of claim 13, further comprising a base upon which the shell is mounted and from which a plurality of supports extend to elevate the base and the shell above a surface.

23. The fuel processor of claim 1, in combination with at least one hydrogen storage device adapted to receive at least a portion of the product hydrogen stream.

24. The fuel processor of claim 1, in combination with a fuel cell stack adapted to receive at least a portion of the hydrogen-rich stream and an oxidant to produce an electric current therefrom.

25. A steam reforming fuel processor, comprising:
a base including a mount for a burner assembly;
an insulating shell mounted on the base and defining with the base an internal compartment;
a burner assembly that includes an ignition region and which is adapted to introduce a heated exhaust stream into a combustion region that is generally centrally located within the shell, wherein the combustion region includes a first portion that is generally proximate the ignition region and a second portion that is distal the ignition region;
a vaporization region adapted to receive a reforming feed stream comprising water and at least one carbon-containing feedstock and to form a vaporized feed stream therefrom, wherein the vaporization region extends radially around the combustion region;
a reforming region containing a plurality of vertically oriented reforming catalyst beds, wherein each reforming catalyst bed includes an inlet region adapted to receive the vaporized feed stream and to produce a reformate stream containing hydrogen gas and other gases therefrom, and an outlet region adapted to exhaust the reformate stream, wherein the plurality of reforming catalyst beds are generally symmetrically and radially spaced around the vaporization region and the combustion region;
an annular distribution manifold adapted to receive the reforming feed stream and to distribute the reforming feed stream to the inlet regions of the reforming catalyst beds, wherein the annular distribution manifold includes a central opening through which at least one of a portion of the burner assembly extends or through which the heated exhaust stream flows;
an annular collection manifold adapted to receive the reformate stream from the outlet regions of the reforming catalyst beds, wherein the collection manifold is in fluid communication with a separation region, wherein the annular collection manifold includes a central opening through which at least one of a portion of the burner assembly extends or through which the heated exhaust stream flows;
a separation region proximate the second portion of the combustion region and adapted to receive the reformate stream and to produce a hydrogen-rich stream containing at least substantially pure hydrogen gas and a byproduct stream containing at least a substantial portion of the other gases, wherein the separation region includes an enclosure containing at least one hydrogen-selective membrane and into which the reformate stream is introduced, with the hydrogen-rich stream being formed from a portion of the reformate stream that passes through the at least one hydrogen-selective membrane and the byproduct stream being formed from a portion of the reformate stream that does not pass through the at least one hydrogen-selective membrane, wherein the at least one hydrogen-selective membrane extends generally transverse to the axis extending at least generally parallel to the plurality of reforming catalyst beds; and
at least one methanation catalyst bed containing a methanation catalyst and adapted to receive the hydrogen-rich stream and to reduce the concentration of any carbon monoxide present in the hydrogen-rich stream.

26. A fuel processor, comprising:
a hydrogen-producing region adapted to receive at least one feed stream and to produce a mixed gas stream containing hydrogen gas and other gases therefrom;
a burner assembly adapted to receive at least one fuel stream and to combust the fuel stream with air to produce a heated exhaust stream, wherein the burner assembly heats at least the hydrogen-producing region with the heated exhaust stream to a temperature of at least 400° C.;
a shroud defining an internal compartment that at least substantially encloses the hydrogen-producing region, wherein the shroud includes a body that includes an inner surface, and an outer surface, and at least one aperture through which the heated exhaust stream exits the shroud, wherein the body is formed from a refractory ceramic material, and further wherein at least one of the inner and the outer surfaces of the body includes at least one layer of a coating selected to be impermeable to the heated exhaust gas stream.

27. The fuel processor of claim 26, wherein the burner assembly is at least partially contained within the compartment.

28. The fuel processor of claim 26, wherein the shroud is mounted on a base plate to which the burner assembly and the hydrogen-producing region are coupled.

29. The fuel processor of claim 26, wherein the shroud is molded as a unitary structure.

30. The fuel processor of claim 26, wherein the coating includes silicone and is applied to the outer surface of the body.

31. The fuel processor of claim 26, wherein the fuel processor includes an exhaust filter through which the heated exhaust stream passes prior to being exhausted from the shroud.

32. The fuel processor of claim 31, wherein the exhaust filter includes a catalytic converter.

33. The fuel processor of claim 32, wherein the exhaust filter is mounted on the shroud.

34. The fuel processor of claim 33, wherein the exhaust filter is sealed within an aperture of the shroud.

35. The fuel processor of claim 26, wherein the hydrogen-producing region is spaced apart from the inner surface of the shroud.

36. The fuel processor of claim 26, wherein the compartment is sealed and thereby adapted to not receive a cooling fluid stream within the compartment.

37. The fuel processor of claim 26, wherein the shroud includes at least one inlet port, at least one outlet port, and a cooling assembly adapted to urge a cooling fluid stream through the compartment.

38. The fuel processor of claim 26, wherein the hydrogen-producing region includes at least one reforming catalyst bed containing a reforming catalyst and adapted to receive a feed stream containing water and at least one carbon-containing feedstock.

39. The fuel processor of claim 26, wherein the fuel processor further includes at least one separation region that is within the compartment and adapted to produce from the mixed gas stream a hydrogen-rich stream containing at least one of a reduced concentration of at least one of the other gases in the mixed gas stream and/or an increased concentration of hydrogen gas compared to the mixed gas stream.

40. The fuel processor of claim 39, wherein the at least one separation region includes at least one hydrogen-selective membrane, with the hydrogen-rich stream formed from a portion of the mixed gas stream that passes through the at least one hydrogen-selective membrane.

41. The fuel processor of claim 40, wherein the at least one hydrogen-selective membrane is formed from at least one of palladium and a palladium alloy.

42. The fuel processor of claim 40, wherein the at least one separation region includes a membrane module containing at least one pair of generally opposed hydrogen-selective membranes separated by a porous support to define a harvesting conduit therebetween, with the hydrogen-rich stream formed from a portion of the mixed gas stream that passes through at least one of the hydrogen-selective membranes into the harvesting conduit.

43. The fuel processor of claim 39, wherein the at least one separation region includes at least one methanation catalyst bed containing a methanation catalyst.

44. The fuel processor of claim 43, wherein the at least one methanation catalyst is adapted to receive the hydrogen-rich stream and to produce from the hydrogen-rich stream a product hydrogen stream containing at least one of a reduced concentration of at least one of the other gases in the hydrogen-rich stream and/or an increased concentration of hydrogen gas compared to the hydrogen-rich stream.
